(19) United States
(12) Patent Application Publication
(10) Pub. No.: US 2023/0106508 A1
(43) Pub. Date: Apr. 6, 2023

(54) SYSTEMS AND METHODS FOR DYNAMIC PROCESSING OF OBJECTS PROVIDED IN VEHICLES WITH COOPERATING PROGRAMMABLE MOTION DEVICES

(71) Applicant: Berkshire Grey Operating Company, Inc., Bedford, MA (US)

(72) Inventors: Thomas Allen, Reading, MA (US); Benjamin Cohen, Somerville, MA (US); John Richard Amend, JR., Belmont, MA (US); Joseph Romano, Arlington, MA (US)

(21) Appl. No.: 17/959,862

(22) Filed: Oct. 4, 2022

Related U.S. Application Data
(60) Provisional application No. 63/252,811, filed on Oct. 6, 2021.

(51) Int. Cl. B65G 67/24

(52) U.S. Cl. CPC B65G 67/24; B65G 2203/044

(57) ABSTRACT

An object processing system is disclosed for dynamically providing the removal of objects from a trailer of a tractor trailer. The object processing system includes a load assessment system for assessing a load characteristic of a plurality of objects within the trailer and for providing load assessment data representative of the load characteristic, an object assessment system for assessing a relative position and relative environment of an object of the plurality of objects responsive to the load assessment data, and for providing object assessment data for the object, and a dynamic engagement system for dynamically engaging the objects within the trailer with either of at least two cooperatively operable programmable motion devices responsive to the object assessment data.

### PRIORITY

The present application claims priority to U.S. Provisional Patent Application No. 63/252,811 filed Oct. 6, 2021, the disclosure of which is hereby incorporated by reference in its entirety.

### BACKGROUND

The invention generally relates to automated, robotic and other object processing systems such as sortation systems and relates in particular to automated and robotic systems intended for use in environments requiring, for example, that a variety of objects (e.g., parcels, packages, and articles etc.) be processed and distributed to several output destinations.

Many parcel distribution systems receive parcels from a vehicle, such as a trailer of a tractor trailer. The parcels are unloaded and delivered to a processing station in a disorganized stream that may be provided as individual parcels or parcels aggregated in groups such as in bags, and may be provided to any of several different conveyances, such as a conveyor, a pallet, a Gaylord, or a bin. Each parcel must then be distributed to the correct destination container, as determined by identification information associated with the parcel, which is commonly determined by a label printed on the parcel or on a sticker applied to the parcel. The destination container may take many forms, such as a bag or a bin.

The sortation of such parcels from the vehicle has traditionally been done, at least in part, by human workers that unload the vehicle, then scan the parcels, e.g., with a hand-held barcode scanner, and then place the parcels at assigned locations. For example many order fulfillment operations achieve high efficiency by employing a process called wave picking. In wave picking, orders are picked from warehouse shelves and placed at locations (e.g., into bins) containing multiple orders that are sorted downstream. At the sorting stage individual articles are identified, and multi-article orders are consolidated, for example into a single bin or shelf location, so that they may be packed and then shipped to customers. The process of sorting these objects has traditionally been done by hand. A human sorter picks an object from an incoming bin, finds a barcode on the object, scans the barcode with a handheld barcode scanner, determines from the scanned barcode the appropriate bin or shelf location for the object, and then places the object in the so-determined bin or shelf location where all objects for that order have been defined to belong. Automated systems for order fulfillment have also been proposed, but such systems still require that objects be first removed from a vehicle for processing if they arrive by vehicle.

Such systems do not therefore, adequately account for the overall process in which objects are first delivered to and provided at a processing station by a vehicle such as a trailer of a tractor trailer. Additionally, many processing stations, such as sorting stations for sorting parcels, are at times, at or near full capacity in terms of available floor space and sortation resources, and there is further a need therefore for systems to unload vehicles and efficiently and effectively provide an ordered stream of objects.

### SUMMARY

In accordance with an aspect, the invention provides an object processing system for dynamically providing the removal of objects from a trailer of a tractor trailer. The object processing system includes a load assessment system for assessing a load characteristic of a plurality of objects within the trailer and for providing load assessment data representative of the load characteristic, an object assessment system for assessing a relative position and relative environment of an object of the plurality of objects responsive to the load assessment data, and for providing object assessment data for the object, and a dynamic engagement system for dynamically engaging the objects within the trailer with either of at least two cooperatively operable programmable motion devices responsive to the object assessment data.

In accordance with another aspect, the invention provides an object processing system for dynamically providing the removal of objects from a trailer of a tractor trailer. The object processing system includes a load assessment system for assessing a load characteristic of a plurality of objects within the trailer and for providing load assessment data representative of the load characteristic, an engagement system including at least two cooperatively operable programmable motion devices for engaging the objects within the trailer responsive to the load assessment data, and a securement detection system for detecting whether any of the plurality of objects within the trailer are secured from movement relative any of the trailer or other objects of the plurality of objects.

In accordance with a further aspect, the invention provides an object processing system for dynamically providing the removal of objects from a trailer of a tractor trailer. The object processing system includes an object assessment system for assessing a relative position and immediate environment of object of the plurality of objects, and for providing object assessment data for the object, an engagement system for dynamically engaging the objects within the trailer with either of at least two cooperatively operable programmable motion devices responsive to the object assessment data, and a securement detection system for detecting whether any of the plurality of objects within the trailer are secured from movement relative any of the trailer or other objects of the plurality of objects.

In accordance with a further aspect, the invention provides a method of providing the removal of a plurality of objects from a trailer of a tractor trailer. The method includes assessing a load characteristic of a plurality of objects within the trailer and for providing load assessment data representative of the load characteristic, assessing a relative position and relative environment of an object of the plurality of objects responsive to the load assessment data, and for providing object assessment data for the object, and dynamically engaging the objects within the trailer with either of at least two cooperatively operable programmable motion devices responsive to the object assessment data.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention;

FIG. 2 shows an illustrative diagrammatic enlarged view of a portion of the object processing system of FIG. 1;

FIG. 3 shows an illustrative diagrammatic flow diagram of a load assessment routine in accordance with an aspect of the present invention;

FIG. 4 shows an illustrative diagrammatic flow diagram of an object assessment routine in accordance with an aspect of the present invention;

FIGS. 5A and 5B show illustrative diagrammatic views of the object processing system of FIG. 1 showing concurrent processing of objects at lower and upper elevations;

FIGS. 6A and 6B show illustrative diagrammatic views of the object processing system of FIGS. 5A and 5B with each programmable motion device having switched lower and upper processing elevations;

FIGS. 7A-7D show illustrative diagrammatic views of the object processing system of FIG. 1 with the programmable motion devices cooperating to pass an object between them, showing grasping an object with a first programmable motion device (FIG. 7A), moving the object toward a second programmable motion device (FIG. 7B), holding the object with both programmable motion devices (FIG. 7C), and moving the object with the second programmable motion device for placement (FIG. 7D);

FIGS. 8A-8D show illustrative diagrammatic views of the object processing system of FIG. 1 with the programmable motion devices cooperating to lift an object together, showing grasping an object with a first programmable motion device (FIG. 8A), moving the object toward a second programmable motion device (FIG. 8B), holding the object with both programmable motion devices (FIG. 8C), and moving the object with both the first and second programmable motion devices for placement (FIG. 8D);

FIG. 9 shows an illustrative diagrammatic flow diagram of a retention system detection routine in accordance with an aspect of the present invention;

FIG. 10 shows an illustrative diagrammatic view of an object processing system processing objects that are retained by netting within a trailer of a tractor trailer;

FIG. 11 shows an illustrative diagrammatic view of an object processing system processing objects that are retained on a wrapped pallet within a trailer of a tractor trailer;

FIGS. 12A and 12B show illustrative diagrammatic views of the object processing system of FIG. 1 showing the pallet removal system in a retracted position (FIG. 12A) and an extended position (FIG. 12B);

FIGS. 13A and 13B show illustrative diagrammatic underside views of the object processing system of FIGS. 12A and 12B showing the pallet removal system in the retracted position (FIG. 13A) and the extended position (FIG. 13B);

FIG. 14 shows an illustrative diagrammatic view of the pallet removal system of FIGS. 12A and 12B showing lifting forks in a lowered position for engaging a pallet;

FIG. 15 shows an illustrative diagrammatic enlarged view of the pallet removal system of FIGS. 12A and 12B showing the lifting forks in an elevated lowered position;

FIG. 16 shows an illustrative diagrammatic view of the pallet removal system of FIGS. 12A and 12B showing the pallet removal system in a partially rotated position;

FIG. 17 shows an illustrative diagrammatic view of the pallet removal system of FIGS. 12A and 12B showing the pallet removal system in a fully rotated position;

FIG. 18 shows an illustrative diagrammatic underside view of the pallet removal system of FIGS. 12A and 12B showing the pallet removal system in a non-rotated position;

FIG. 19 shows an illustrative diagrammatic underside view of the pallet removal system of FIGS. 12A and 12B showing the pallet removal system in a fully rotated position;

FIG. 20 shows an illustrative diagrammatic side view of the pallet removal system of FIGS. 12A and 12B showing a pallet being removed from the trailer of the tractor trailer;

FIG. 21 shows an illustrative diagrammatic view of the pallet removal system of FIG. 20 showing the pallet removed from the trailer and rotated;

FIG. 22 shows an illustrative diagrammatic back side view of the pallet removal system of FIG. 21 showing the pallet lowered onto a shipping dock; and

FIG. 23 shows an illustrative diagrammatic back side view of the pallet removal system rotated and retracted away from the deposited pallet.

The drawings are shown for illustrative purposes only.

### DETAILED DESCRIPTION

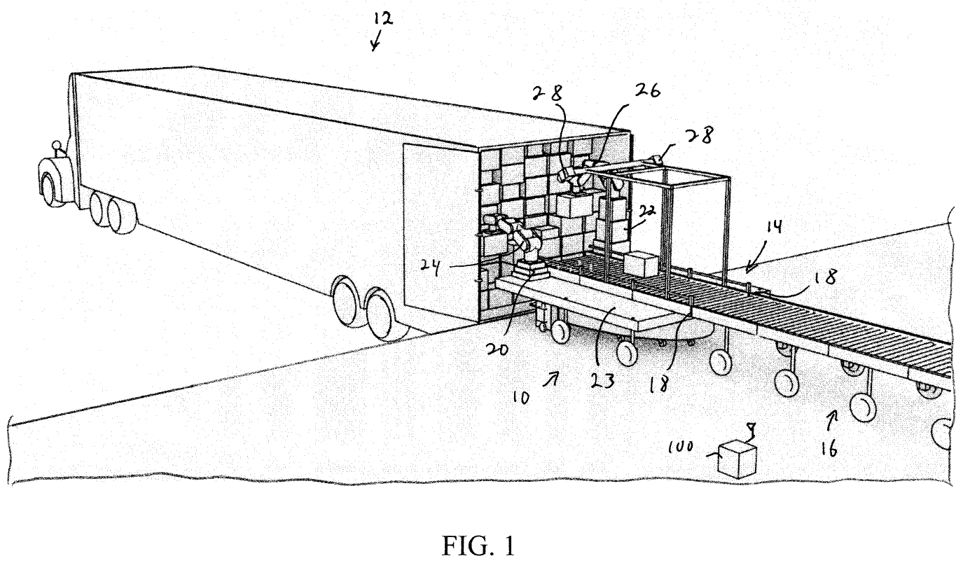

In accordance with various aspects, the invention provides a dynamic engagement system for engaging objects within a trailer of a tractor trailer. With reference for example, to FIG. 1, a dynamic engagement system 10 may engage objects within a trailer 12 and include a chassis 14 that couples to a warehouse conveyor 16 via couplings 18. The chassis 14 (and the conveyor 16) are movable on wheels for permitting the engagement system 10 to enter into (and back out of) the trailer 12. The wheels on the chassis 14 are powered and the control system is remotely coupled to one or more computer processing systems 100.

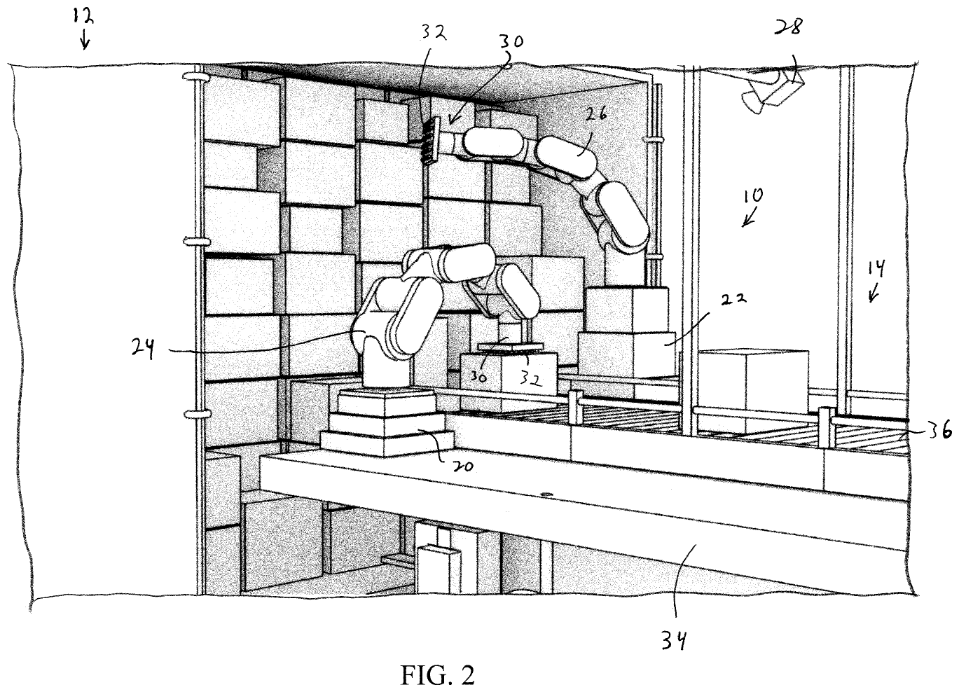

With further reference to FIG. 2, the engagement system 10 includes two programmable motion devices 24, 26, each of which includes an end effector 30 with, for example, a plurality of vacuum cups that are coupled to a vacuum source. The programmable motion devices 24, 26 are mounted on automated adjustable height bases 20, 22 that cooperate with the programmable motion devices 24, 26 to provide further vertical ranges of motion to the end effectors 30. The bases 20, 22 are mounted on a support structure 34 that also includes a chassis conveyor 36 that couples to the warehouse conveyor 16 (shown in FIG. 1) via couplings 18. In accordance with various aspects, the programmable motion devices 24, 26 are cooperatively operable to efficiently unload objects from the trailer 12 as discussed in more detail below.

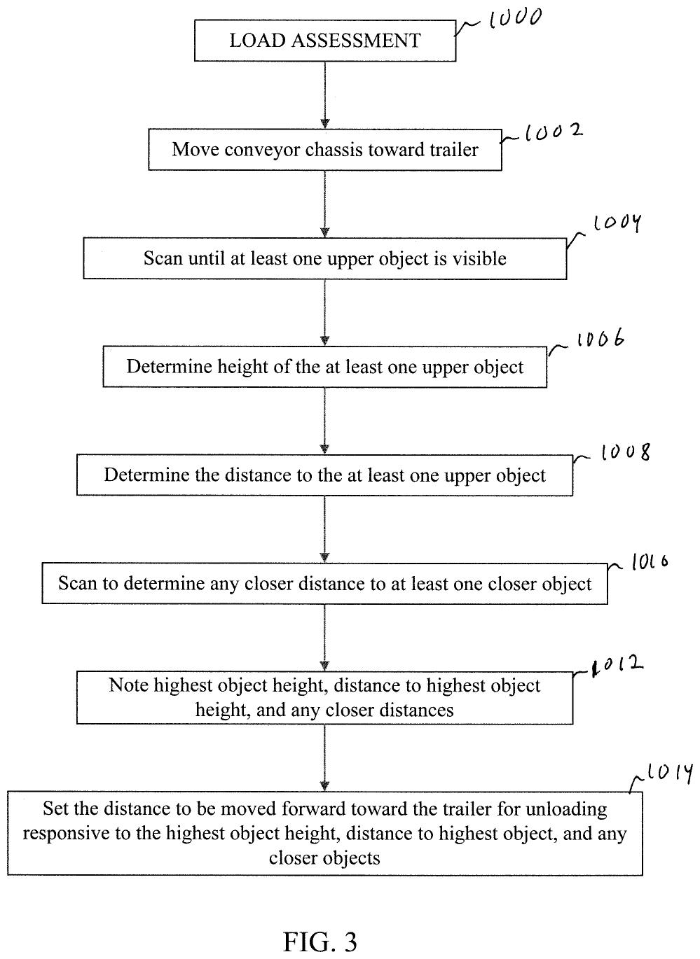

Initially, the load of objects within a trailer may be assessed. With reference to FIG. 3, a load assessment routine may begin (step 1000) by moving the conveyor chassis toward the trailer (step 1002). The system may then scan until at least one upper object is visible (step 1004). Distance and position detection sensors in the perception units 28 are then used to determine a height of the at least one upper object (step 1006) as well as a distance to the at least one upper object (step 1008). The panel is then further lowered to determine whether (and if so where) any lower objects are provided in the trailer that are closer in distance to the dynamic engagement system than the at least one upper object (step 1008). The highest object height, distance to the highest object, and distances to any closer objects are noted (step 1012), and the system the sets the distance to be moved forward toward the trailer for unloading responsive to the highest object height, distance to the highest object, and distances to any closer objects (step 1014). In particular, the chassis is positioned near the nearest objects.

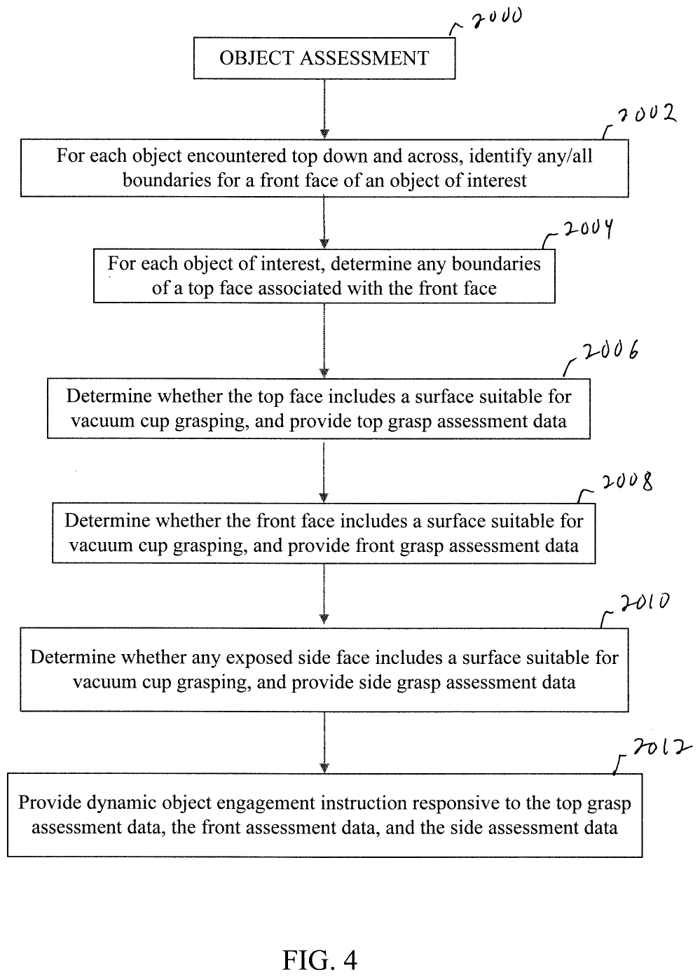

Once the chassis is positioned, each facing object is assessed. In particular for example and with reference to FIG. 4, an object assessment routine may begin (step 2000) by evaluating object boundaries. For each object encountered top down and across, all boundaries of a front face of each object of interest are identified (step 2002). For each object of interest, the system will also determine any boundaries of a top face associated with the front face (step 2004). With this information, the system may determine whether the top face includes a surface suitable for vacuum cup grasping, and provide top gasp assessment data (step 2006). The system may also determine whether the front face includes a surface suitable for vacuum cup grasping, and provide front gasp assessment data (step 2008). The system may also determine whether any exposed side face includes a surface suitable for vacuum cup grasping, and provide side gasp assessment data (step 2010). The system may then provide dynamic object engagement instructions responsive to the top grasp assessment data, the front grasp assessment data, and the side grasp assessment data (step 2012). The processing is performed by one or more computer processing systems 100 in communication (either directly or wirelessly) with the programmable motion devices, perception units, conveyor systems and pallet removal systems discussed herein.

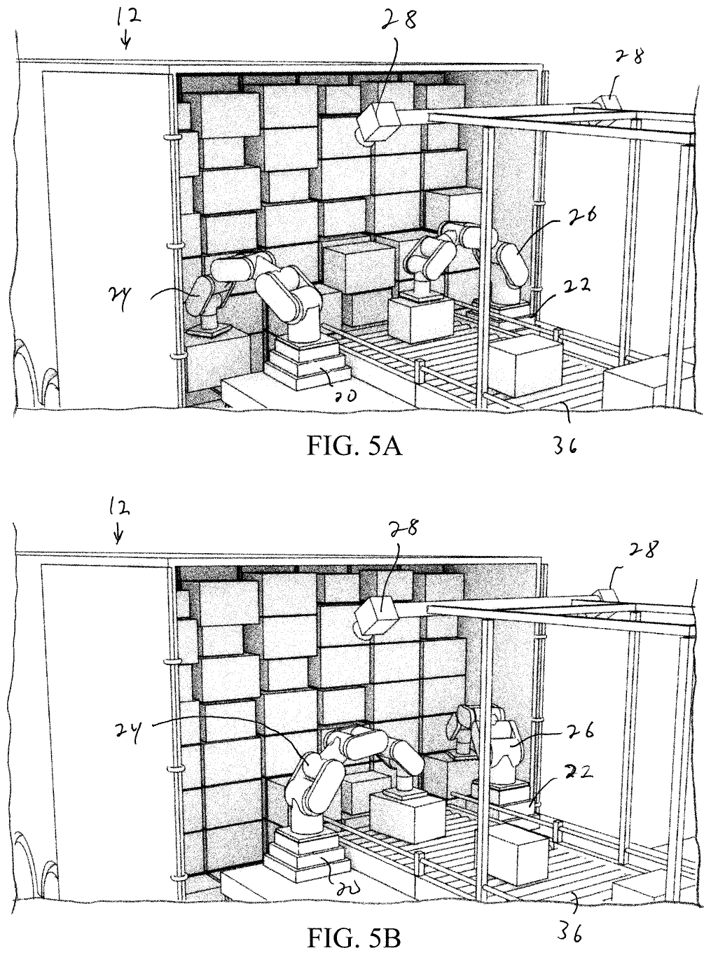

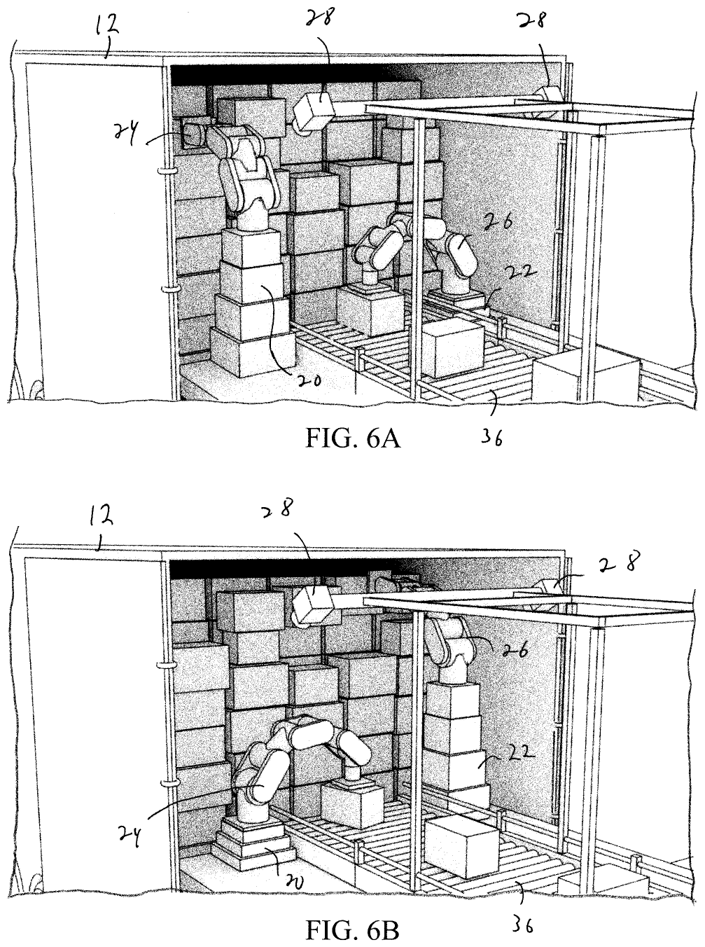

In accordance with various aspects, the programmable motion devices 24, 26 are cooperatively operable to provide dynamic engagement of the objects in the trailer. The cooperative operability, for example, may minimize any time that one programmable motion device must wait for the other programmable motion device. This may be achieved by recognizing that the processing of objects that are closer to the upper elevations within the trailer may require more time (to be grasped, moved and placed onto the conveyor 36) than do objects that are not near the upper elevations within the trailer. With reference to FIGS. 5A and 5B, the programmable motion devices 24, 26 may both process objects at comparable lower elevations at the same time, while (and with reference to FIGS. 6A and 6B), the programmable motion devices 24, 26 may both process objects at comparable upper elevations at the same time. In this way, the devices 24, 26 may most efficiently alternate grasping objects within the trailer and placing them onto the chassis conveyor 36. With both devices grasping objects at the same elevation, the travel time from grasping an object to placement on the conveyor 36 is closely matched as between the devices 24, 26.

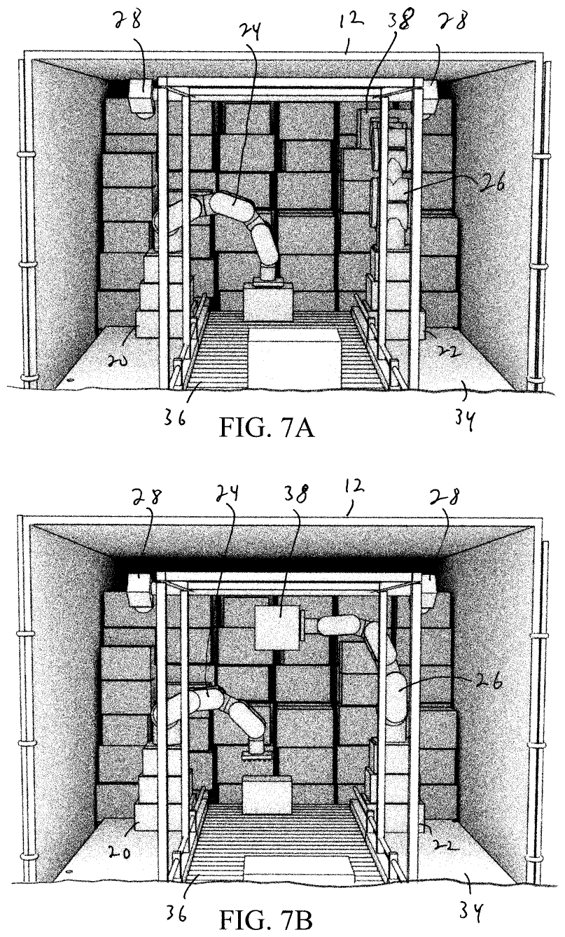

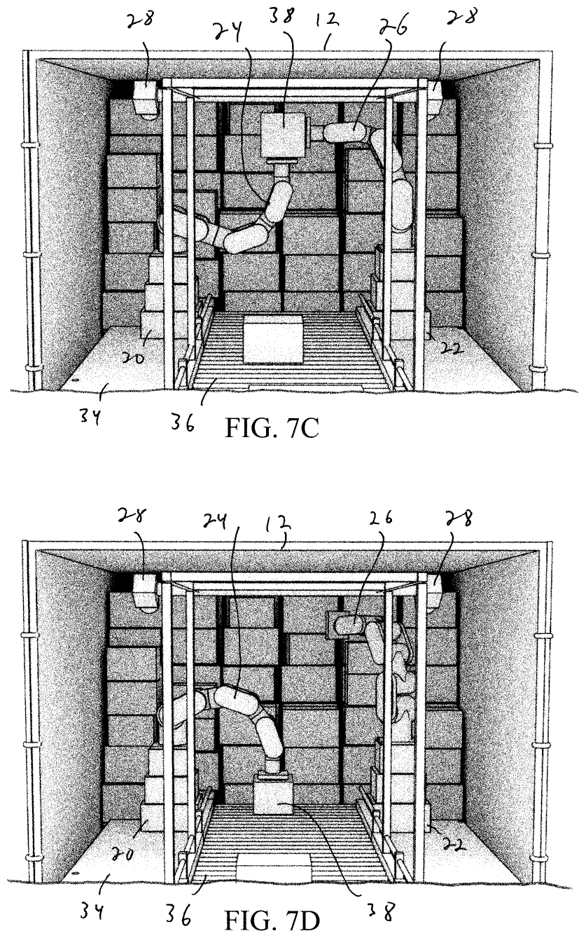

In accordance with further aspects, the cooperative operability may involve one programmable motion device grasping an object, and moving the object toward a commonly reachable (by both devices 24, 26) location. The other (second) programmable motion device may then grasp the object, the first programmable motion device then releases the object, and the second programmable motion device then moves the object to the conveyor 36 on which it is placed. With reference to FIGS. 7A-7D, one programmable motion device (e.g., 26) may grasp an object (e.g., 38) as shown in FIG. 7A. The programmable motion device may then move the object to a commonly reachable location as shown in FIG. 7B. A commonly reachable location may be a location at which both programmable motion devices may be able to reach the object at the same time. The other programmable motion device 24 may then also grasp the object (as shown in FIG. 7C), and the first programmable motion device 26 may then release the object. The programmable motion device 24 may then move the object 38 to the conveyor 36, and place the object onto the conveyor 36 (as shown in FIG. 7D). With both devices working together in this way, the time to unload objects from the trailer may be improved in certain applications, for example, where the programmable motion devices must reach further distances to grasp objects, or where object are required to be placed slowly onto the conveyor 36.

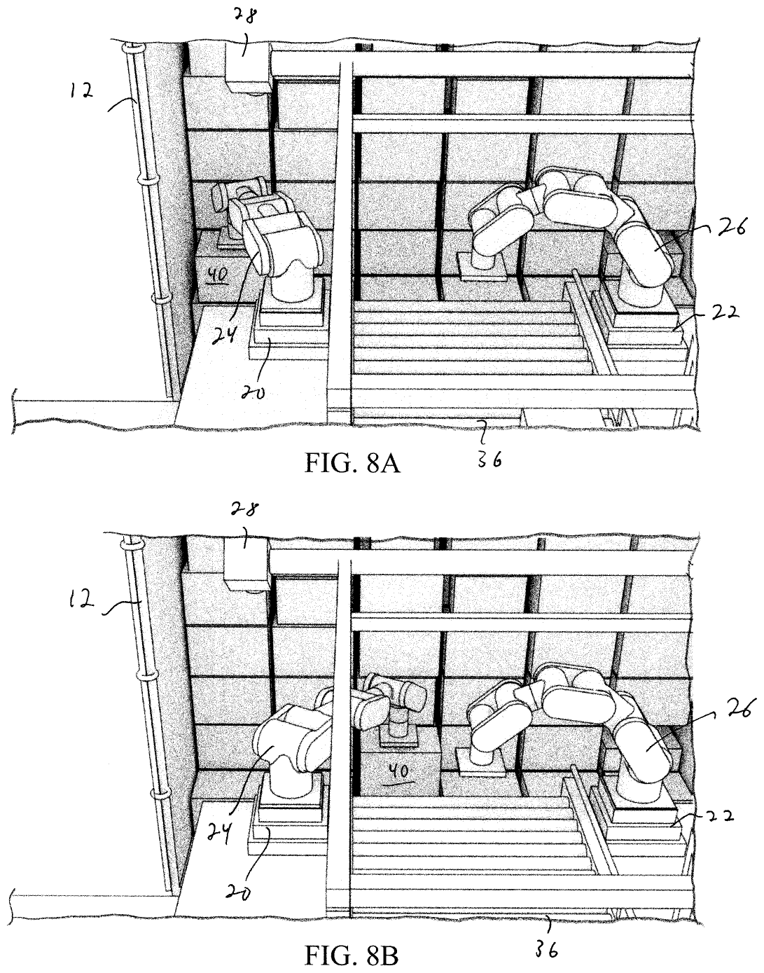

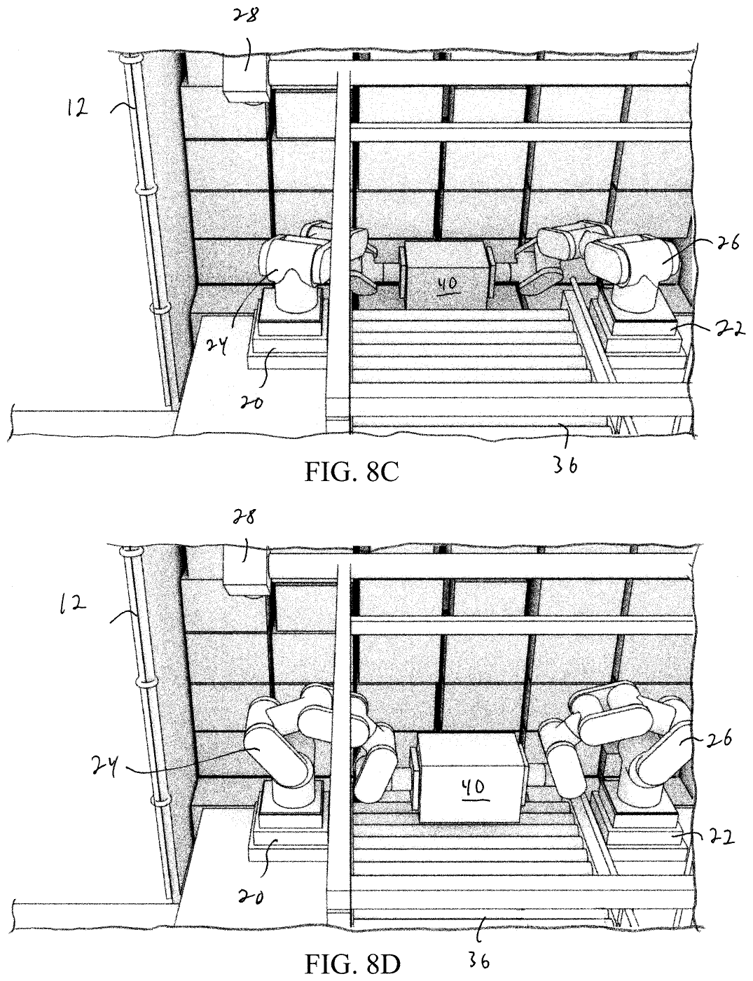

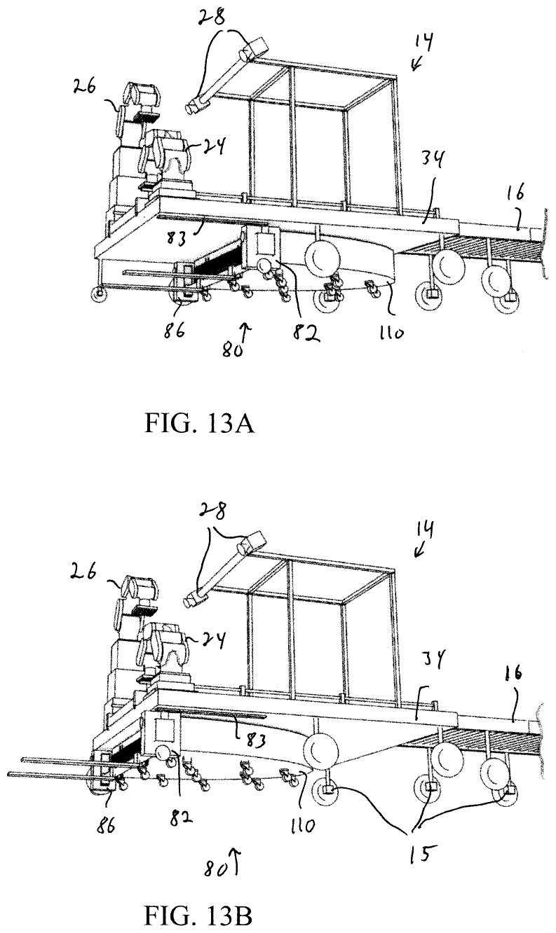

In accordance with further aspects, the cooperative operability may involve the two programmable motion devices working together to lift a heavy object. The cooperative operability may involve one programmable motion device grasping an object 40, and moving sliding the object to a commonly reachable (by both devices 24, 26) location. The other (second) programmable motion device may then also grasp the object, and the first and second programmable motion devices may then together lift the object to the conveyor 36 on which it is placed. With reference to FIGS. 8A-8D, one programmable motion device (e.g., 24) may grasp an object (e.g., 40) as shown in FIG. 8A. If the object is determined to be heavy (either by having the device 24 try to lift the object, or by accessing a database with a known identity of the object) the programmable motion device may then slide the object toward a commonly reachable location at which both programmable motion devices 24, 26 may be able to grasp the object at the same time (as shown in FIG. 8B). The other programmable motion device (e.g., 26) may then also grasp the object as shown in FIG. 8C. The grasp position of the first programmable motion device 24 may also be adjusted, and the object 40 may be further moved with the new grasp position. As shown in FIG. 8D, the two programmable motion devices may then cooperate to lift the object onto the conveyor 36. With both devices working together in this way, the system may be able to handle the processing of heavier objects, may increase speed of handling heavier objects, and may increase system life by reducing loads on individual programmable motion devices. Movement of the dynamic engagement system is provided through the one or more processing systems 100 in communication with the perception system 28, the articulated arms 24 26, the automated adjustable bases 20, 22, and the conveyor wheels actuators (e.g., 15 shown in FIGS. 13A and 13B).

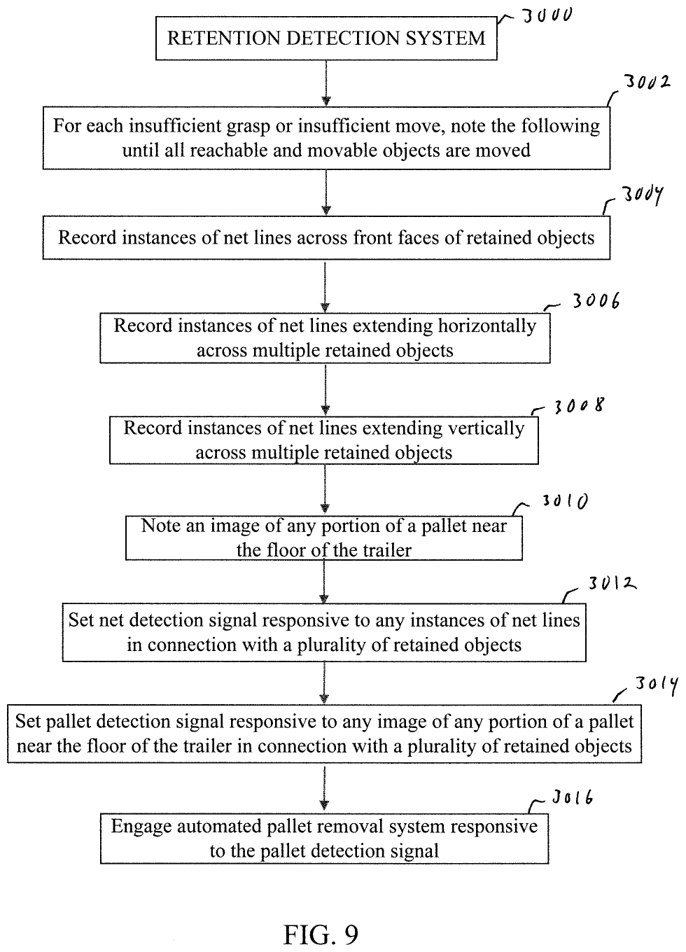

A retention detection system may also be employed to determine whether a retention system is present within a trailer (e.g., such as a restraining net, wall, or set of objects that are wrapped together, for example and provided on a pallet). With reference to FIG. 9, the retention detection system begins (step 3000) by being triggered for each object that may not be sufficiently processed. In particular, for each insufficient grasp of an object or insufficient attempted move of an object, the following data is collected (step 3002). This is done until the panel is lowered to its lowest point and all reachable and movable objects are moved. The system then records instances of net lines across front faces of retained objects (step 3004), and then records instances of net lines extending horizontally across multiple retained objects (step 3006). The system then records instances of net lines extending vertically across multiple retained objects (step 3008), and then records any image of any portion of a pallet near the floor of the trailer (step 3010). The system then sets a net detection signal responsive to any instances of net lines in connection with a plurality of retained objects (step 3012), and/or then sets a pallet detection signal responsive to any image of any portion of a pallet near the floor of the trailer in connection with a plurality of retained objects (step 3014). The system then engages an automated pallet removal system responsive to the pallet detection signal (step 3016). Again, all processing may be performed by one or more computer processing systems 100.

During the removal of objects therefore, if any object may not be removed (either may not be able to be grasped properly or may not be movable due to an obstruction), the system will run the retaining detection routine to determine whether any of the objects are retained within the trailer. The system will continue, moving to a next object until all objects that may be moved. Each time an object is identified as being not movable (again either not graspable or is blocked), the system will run the retaining detection routine. The retaining detection routine may be run on the one or more computer processing systems 100 with perception data from the perception units 28, and may analyze image data in combination with object grasp attempt data to identify whether any retention system is inhibiting the removal of objects from the trailer. If a retaining feature is present, the system will run for each object that is found to be not movable.

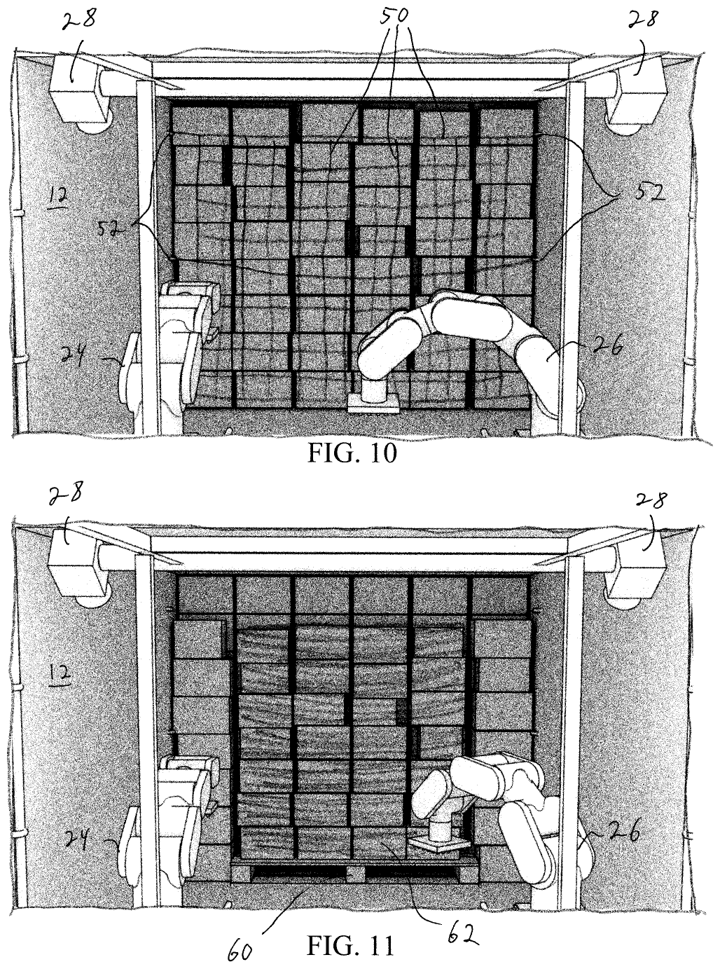

A combination of the results of the multiple executions of the routine provides duplicative results that should confirm the type of retaining feature present. For example, FIG. 10 shows a netting 50 fastened to an attachment mount that spans the width and height of the trailer. Such netting may be installed manually upon loading of the trailer, and may be required to be removed manually with unpacking the trailer. An alarm (light and/or sound) will be triggered if a netting is detected by the system, and removed by human personnel.

Alternatively, as the movable objects are removed, an image of an exposed end of a pallet at the floor of the trailer may be detected. The objects on the pallet may be wrapped (accounting for the system being unable to move individual objects), and upon detection of the pallet, the system will trigger a pallet removal command. FIG. 11 for example, shows a pallet 60 on which objects are provided within a wrapping (e.g., clear plastic) 62. Objects within the wrapping 62 on the pallet will not be movable by the end effector 30, and the system will run the retaining detection routine. Once the bottom of the trailer becomes clear, the pallet 60 will become visible to the perception system 28, and the system will register that a pallet is present. Again, an alarm (light and/or sound) will be triggered if a pallet is detected by the system, and the pallet and its associated objects may be removed by human personnel.

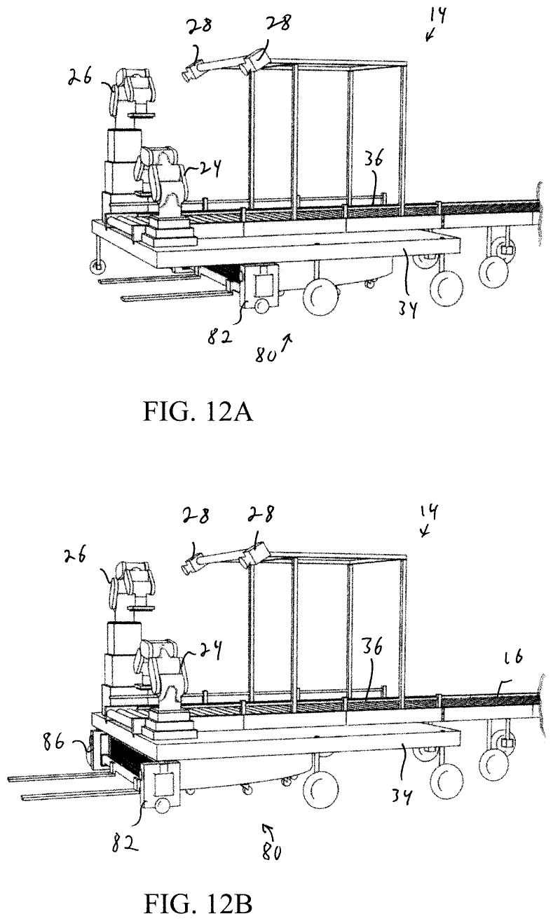

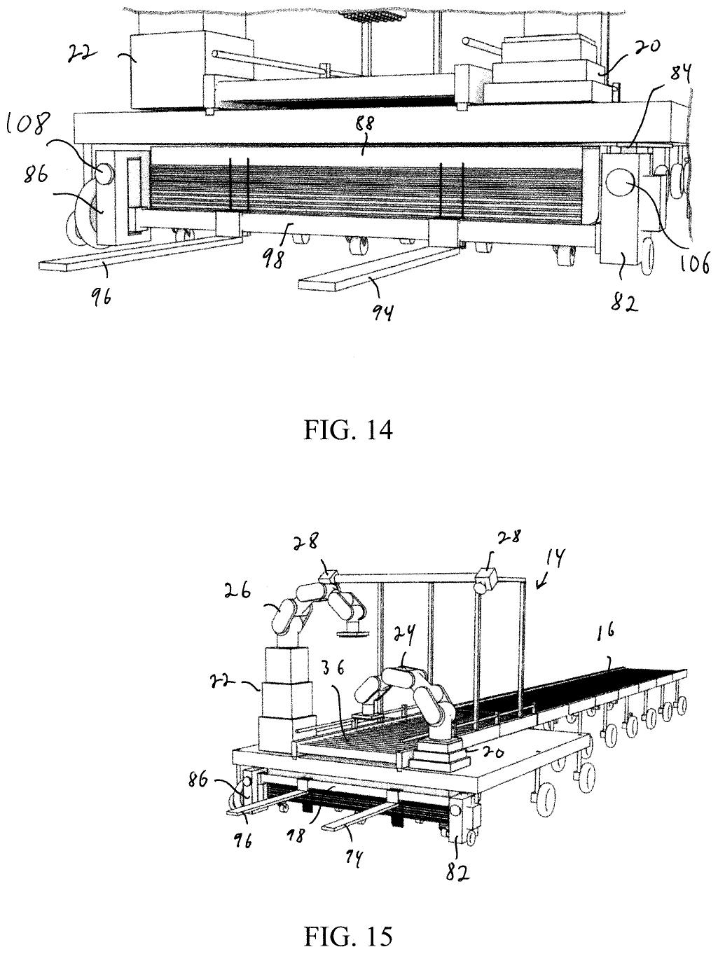

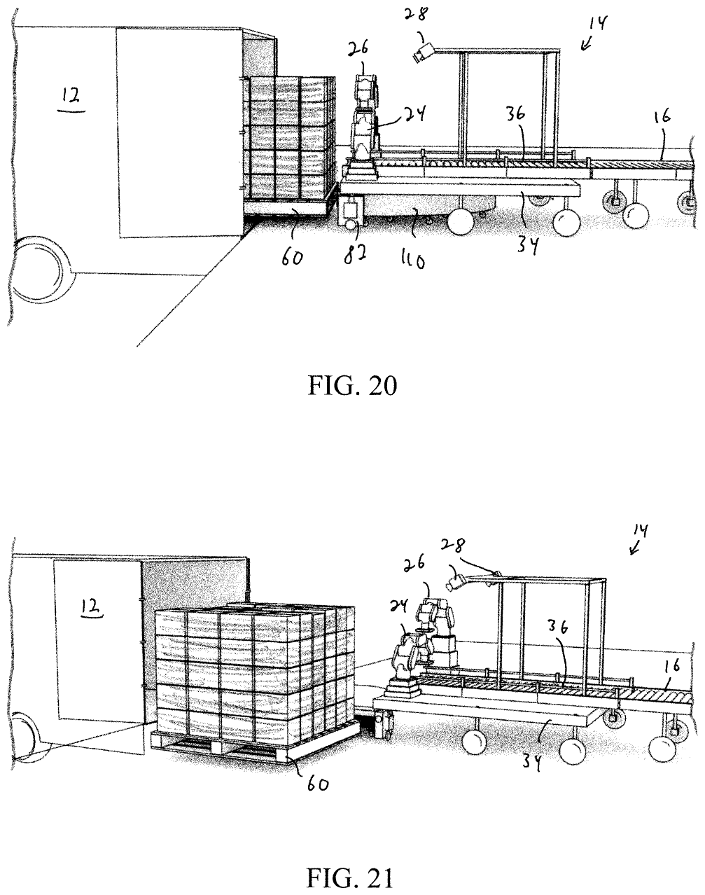

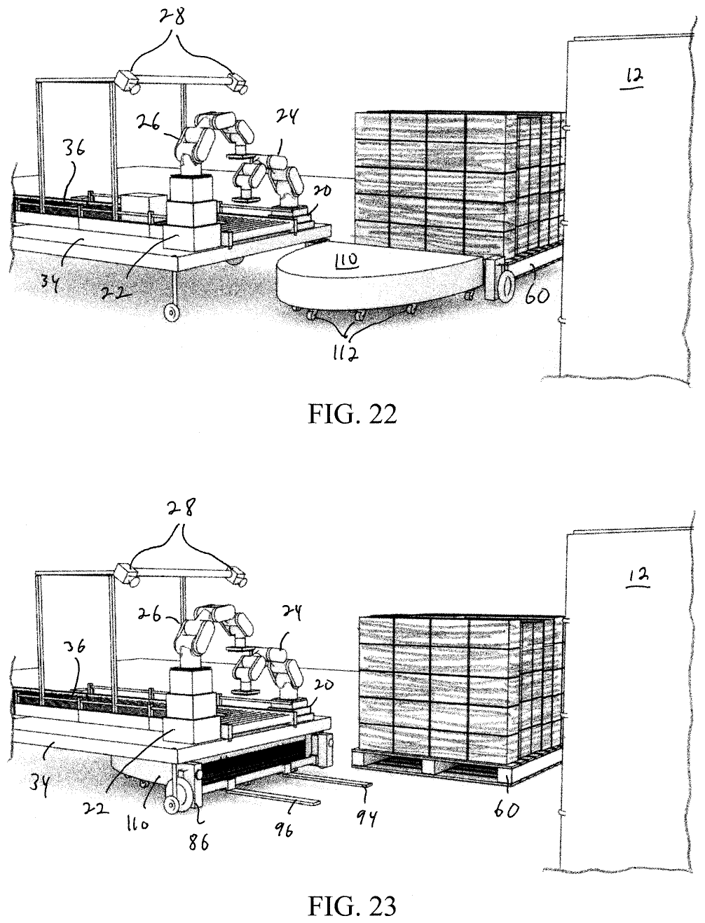

In accordance with further aspects, when the system detects the presence of a pallet as above, the system may employ an automated pallet removal system. In particular and with reference to FIGS. 12A and 12B, the system may include a pallet removal system 80 that includes a slidable pivot end 82 that first moves linearly along a track 83 (as shown in FIGS. 13A, 13B, 18 and 19), and then rotates with respect to the chassis conveyor 14 by a pivot pin 84 (shown in FIG. 14). The system also includes a rotating swing end 86, and both of the ends 82, 86 are coupled to a swing bar 88 as shown in FIG. 15. The swing bar 88 is attached to a counterweight portion 110 (shown in FIG. 22) that is supported by a plurality of heavy-duty casters 112. The system includes the track 83 along which the pin 84 is guided as the assembly moves linearly (powered by the active wheels on the ends 82, 86) to move the assembly to the end of the chassis 14. The pallet removal system 80 also includes a pair of forks 94, 96 that are mounted to a cross bar 98, and the cross bar 98 may be actively raised or lowered along tracks 102, 104 as controlled by the one or more computer processing systems. FIG. 20 shows the forks 94, 96 and the cross bar 98 in the raised position. The pallet removal system 80 may also include one or more perception systems 106, 108 (shown in FIG. 14) to aid the pallet removal process.

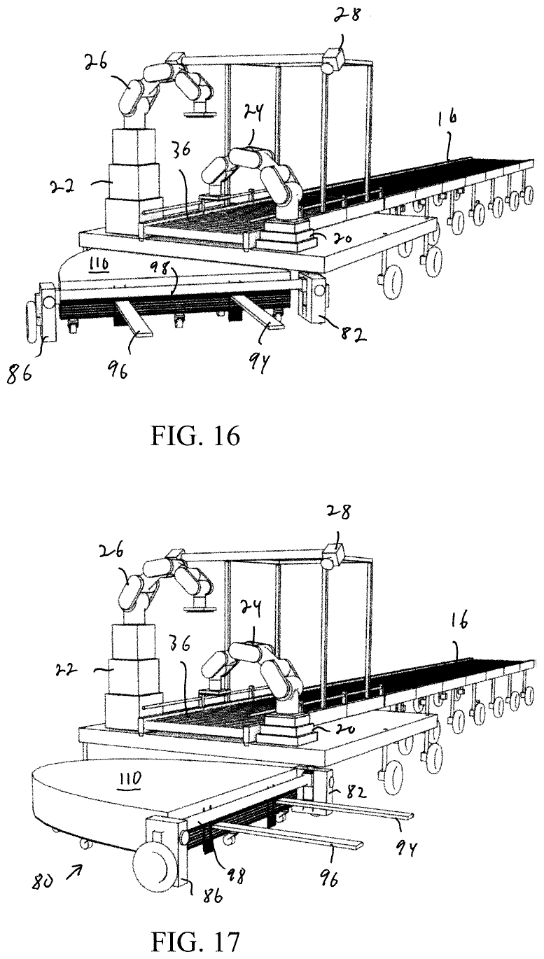

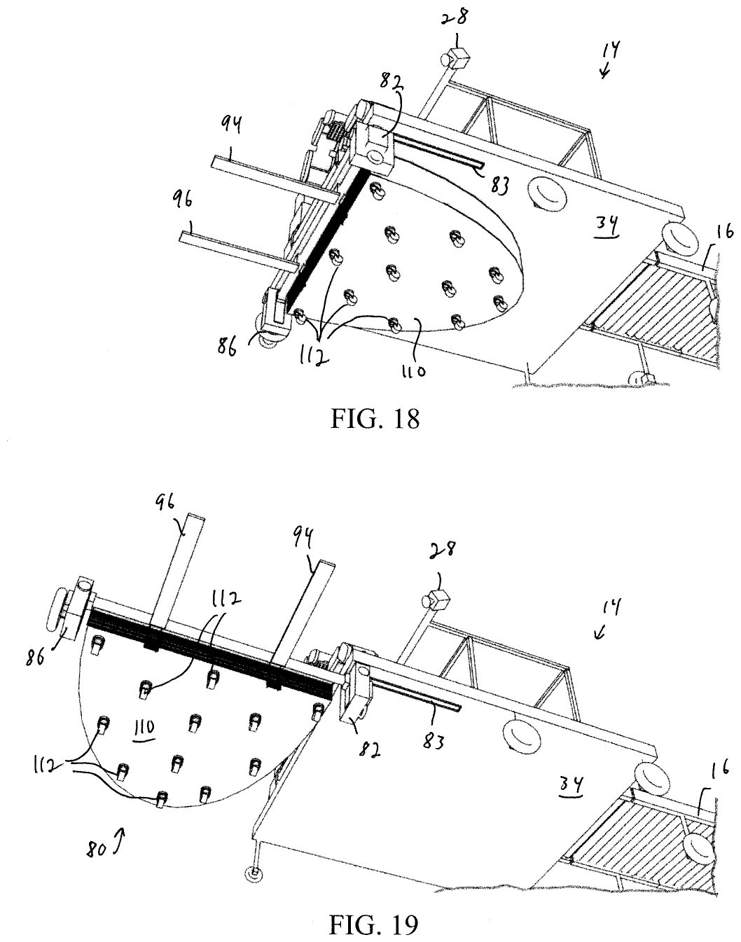

With reference to FIGS. 16 and 17, the pallet removal system 80 may be rotated with respect to the chassis 14 about the pin 84 (e.g., to 45 degrees as shown in FIGS. 16, and to 90 degrees as shown in FIG. 17). FIG. 18 shows an underside view of the pallet removal system 80 under the chassis conveyor 14, and FIG. 19 shows an underside view of the pallet removal system rotated 90 degrees (as in FIG. 17). The counterweight 110 facilitates lifting of a pallet, and casters 112 (together with wheels under the pivot end 82 and swing end 86) support the weight of the counterweight 110 and the pallet. FIG. 20 shows a pallet of objects being removed from the trailer, and FIG. 21 shows the pallet of objects rotated 90 degrees by the removal system. FIG. 22 shows an opposite side view of the pallet are rotated 90 degrees in FIG. 21, and FIG. 23 shows the pallet removed and unloaded from the removal system. The removed and unloaded pallet is no longer obstructing the removal of objects from the trailer, and the dynamic engagement system may re-enter the trailer and again begin removing objects. The removed and unloaded pallet may be processed by human personnel.

Those skilled in the art will appreciate that numerous modifications and variations may be made to the above disclosed embodiments without departing from the spirit and scope of the present invention.

What is claimed is:

1. An object processing system for dynamically providing the removal of objects from a trailer of a tractor trailer, said object processing system comprising:
a load assessment system for assessing a load characteristic of a plurality of objects within the trailer and for providing load assessment data representative of the load characteristic;
an object assessment system for assessing a relative position and relative environment of an object of the plurality of objects responsive to the load assessment data, and for providing object assessment data for the object; and
a dynamic engagement system for dynamically engaging the objects within the trailer with either of at least two cooperatively operable programmable motion devices responsive to the object assessment data.

2. The object processing system as claimed in claim 1, wherein the load assessment system includes a plurality of perception units that provide perception data, and wherein the load characteristic includes a height of the plurality of objects.

3. The object processing system as claimed in claim 1, wherein the load assessment system includes a plurality of perception units that provide perception data, and wherein the load characteristic includes a proximity of the plurality of objects to a back end of the trailer.

4. The object processing system as claimed in claim 1, wherein the cooperatively operable programmable motion devices operate to maintain comparable grasp-to-placement timing as between the cooperatively operable programmable motion devices.

5. The object processing system as claimed in claim 4, wherein the cooperatively operable programmable motion devices operate to maintain comparable grasp-to-placement timing by grasping objects at comparable elevations within the trailer.

6. The object processing system as claimed in claim 1, wherein the cooperatively operable programmable motion devices operate in series such that one programmable motion device passes an object to the other programmable motion device prior to placement on an output conveyor.

7. The object processing system as claimed in claim 1, wherein the cooperatively operable programmable motion devices operate together to lift an object for movement together to an output conveyor.

8. The object processing system as claimed in claim 1, wherein the object processing system further includes a securement detection system for detecting whether any of the plurality of objects within the trailer are secured from movement relative any of the trailer or other objects of the plurality of objects.

9. The object processing system as claimed in claim 8, wherein the securement detection system determines whether a subset of the plurality of objects is provided on a pallet.

10. The object processing system as claimed in claim 9, wherein the object processing system further includes a pallet removal system of engaging the pallet and removing the pallet and the subset of the plurality of objects from the trailer.

11. The object processing system as claimed in claim 10, wherein the pallet removal system includes pallet lift forks that are mounted on a swing arm under the dynamic engagement system.

12. The object processing system as claimed in claim 9, wherein the securement detection system determines whether a subset of the plurality of objects is retained by a net within the trailer.

13. An object processing system for dynamically providing the removal of objects from a trailer of a tractor trailer, said object processing system comprising:
a load assessment system for assessing a load characteristic of a plurality of objects within the trailer and for providing load assessment data representative of the load characteristic;
an engagement system including at least two cooperatively operable programmable motion devices for engaging the objects within the trailer responsive to the load assessment data; and
a securement detection system for detecting whether any of the plurality of objects within the trailer are secured from movement relative any of the trailer or other objects of the plurality of objects.

14. The object processing system as claimed in claim 13, wherein the load assessment system includes a plurality of perception units that provide perception data, and wherein the load characteristic includes a height of the plurality of objects.

15. The object processing system as claimed in claim 13, wherein the cooperatively operable programmable motion devices operate to maintain comparable grasp-to-placement timing as between the cooperatively operable programmable motion devices.

16. The object processing system as claimed in claim 15, wherein the cooperatively operable programmable motion devices operate to maintain comparable grasp-to-placement timing by grasping objects at comparable elevations within the trailer.

17. The object processing system as claimed in claim 13, wherein the cooperatively operable programmable motion devices operate in series such that one programmable motion device passes an object to the other programmable motion device prior to placement on an output conveyor.

18. The object processing system as claimed in claim 13, wherein the cooperatively operable programmable motion devices operate together to lift an object for movement together to an output conveyor.

19. The object processing system as claimed in claim 13, wherein the securement detection system determines whether a subset of the plurality of objects is provided on a pallet.

20. The object processing system as claimed in claim 18, wherein the object processing system further includes a pallet removal system of engaging the pallet and removing the pallet and the subset of the plurality of objects from the trailer.

21. The object processing system as claimed in claim 19, wherein the pallet removal system includes pallet lift forks that are mounted on a swing arm under the dynamic engagement system.

22. The object processing system as claimed in claim 13, wherein the securement detection system determines whether a subset of the plurality of objects is retained by a net within the trailer.

23. An object processing system for dynamically providing the removal of objects from a trailer of a tractor trailer, said object processing system comprising:
an object assessment system for assessing a relative position and immediate environment of object of the plurality of objects, and for providing object assessment data for the object;
an engagement system for dynamically engaging the objects within the trailer with either of at least two cooperatively operable programmable motion devices responsive to the object assessment data; and
a securement detection system for detecting whether any of the plurality of objects within the trailer are secured from movement relative any of the trailer or other objects of the plurality of objects.

24. The object processing system as claimed in claim 23, wherein the cooperatively operable programmable motion devices operate to maintain comparable grasp-to-placement timing as between the cooperatively operable programmable motion devices.

25. The object processing system as claimed in claim 24, wherein the cooperatively operable programmable motion devices operate to maintain comparable grasp-to-placement timing by grasping objects at comparable elevations within the trailer.

26. The object processing system as claimed in claim 23, wherein the cooperatively operable programmable motion devices operate in series such that one programmable motion device passes an object to the other programmable motion device prior to placement on an output conveyor.

27. The object processing system as claimed in claim 23, wherein the cooperatively operable programmable motion devices operate together to lift an object for movement together to an output conveyor.

28. The object processing system as claimed in claim 23, wherein the securement detection system determines whether a subset of the plurality of objects is provided on a pallet.

29. The object processing system as claimed in claim 28, wherein the object processing system further includes a pallet removal system of engaging the pallet and removing the pallet and the subset of the plurality of objects from the trailer.

30. The object processing system as claimed in claim 29, wherein the pallet removal system includes pallet lift forks that are mounted on a swing arm under the dynamic engagement system.

31. The object processing system as claimed in claim 23, wherein the securement detection system determines whether a subset of the plurality of objects is retained by a net within the trailer.

32. The object processing system as claimed in claim 23, wherein the object processing system further includes a load assessment system for assessing a load characteristic of a plurality of objects within the trailer and for providing load assessment data representative of the load characteristic.

33. The object processing system as claimed in claim 32, wherein the load assessment system includes a plurality of perception units that provide perception data, and wherein the load characteristic includes a height of the plurality of objects.

34. The object processing system as claimed in claim 32, wherein the load assessment system includes a plurality of perception units that provide perception data, and wherein the load characteristic includes a proximity of the plurality of objects to a back end of the trailer.

35. A method of providing the removal of a plurality of objects from a trailer of a tractor trailer, said method comprising:
assessing a load characteristic of a plurality of objects within the trailer and for providing load assessment data representative of the load characteristic;
assessing a relative position and relative environment of an object of the plurality of objects responsive to the load assessment data, and for providing object assessment data for the object; and
dynamically engaging the objects within the trailer with either of at least two cooperatively operable programmable motion devices responsive to the object assessment data.

36. The method as claimed in claim 35, wherein the method further includes operating the cooperatively operable programmable motion devices to maintain comparable grasp-to-placement timing as between the cooperatively operable programmable motion devices.

37. The method as claimed in claim 35, wherein the method further includes operating the cooperatively operable programmable motion devices to maintain comparable grasp-to-placement timing by grasping objects at comparable elevations within the trailer.

38. The method as claimed in claim 35, wherein the method further includes operating the cooperatively operable programmable motion devices in series such that one programmable motion device passes an object to the other programmable motion device prior to placement on an output conveyor.

39. The method as claimed in claim 35, wherein the method further includes operating the cooperatively operable programmable motion devices together to lift an object for movement together to an output conveyor.
